(19) United States
(12) Patent Application Publication
(10) Pub. No.: US 2023/0353249 A1
(43) Pub. Date: Nov. 2, 2023

(54) OPTICAL TRANSMITTING APPARATUS, OPTICAL TRANSMITTING METHOD AND OPTICAL TRANSMISSION SYSTEM

(71) Applicant: NIPPON TELEGRAPH AND TELEPHONE CORPORATION, Tokyo (JP)

(72) Inventors: Toshiaki SHITABA, Musashino-shi (JP); Tomoaki YOSHIDA, Musashino-shi (JP); Akihiro TANABE, Musashino-shi (JP); Takashi MITSUI, Musashino-shi (JP)

(73) Assignee: NIPPON TELEGRAPH AND TELEPHONE CORPORATION, Tokyo (JP)

(21) Appl. No.: 18/019,280

(22) PCT Filed: Sep. 1, 2020
(86) PCT No.: PCT/JP2020/033052

§ 371 Date: Feb. 2, 2023

(51) Int. Cl. H04B 10/516; H04B 10/50

(52) U.S. Cl. CPC H04B 10/516; H04B 10/503

(57) ABSTRACT

An optical transmission device includes a distribution unit which generates a first modulated signal and a second modulated signal by distribution processing for an input signal; a first phase modulator which generates a first optical signal phase-modulated in accordance with the first modulated signal by using a laser beam based on a first oscillation frequency; a phase adjustment unit which generates the second modulated signal of a phase opposite to a phase of the first modulated signal; a second phase modulator which generates a second optical signal phase-modulated in accordance with the second modulated signal of the opposite phase by using a laser beam based on a second oscillation frequency; a multiplexing unit which multiplexes the first optical signal and the second optical signal; and a detection unit which generates a frequency-modulated signal by performing square-law detection processing on a result of multiplexing.

### TECHNICAL FIELD

The present invention relates to an optical transmission device, an optical transmission method, and an optical transmission system.

### BACKGROUND ART

An optical transmission system which collectively converts frequency division multiplexing (FDM) signals into frequency modulation (FM) signals (hereinafter referred to as an “FM conversion method”) has been introduced into video signal distribution systems (refer to Non Patent Documents 1 and 2).

FIG. 4 is a diagram showing a first example of a configuration of a frequency modulation unit provided in an optical transmission device of such an optical transmission system. A frequency modulation unit 100 includes a first laser oscillator 101, a second laser oscillator 102, a phase modulator 103, a multiplexing unit 104, and a detection unit 105.

The first laser oscillator 101 is a laser diode. The first laser oscillator 101 generates a laser beam on the basis of a first oscillation frequency “f1”. A video signal (modulated signal) of cable television broadcasting in a frequency-multiplexed signal is input to the first laser oscillator 101 from a head-end device (not shown). The first laser oscillator 101 generates an optical signal directly modulated in accordance with a video signal of cable television broadcasting by using a laser beam based on the first oscillation frequency “f1”.

The second laser oscillator 102 is a laser diode. The second laser oscillator 102 generates a laser beam on the basis of a second oscillation frequency “f2”. Hereinafter, the video signal whose phase has been inverted is referred to as a “video signal of an opposite phase”. A video signal of an opposite phase of the cable television broadcast in the frequency-multiplexed signal is input to the second laser oscillator 102 from the head-end device (not shown). The first laser oscillator 101 generates an optical signal directly modulated in accordance with a video signal of an opposite phase by using a laser beam based on a second oscillation frequency “f2”.

An optical signal directly modulated in accordance with a video signal of cable television broadcasting is input to the phase modulator 103 from the first laser oscillator 101. Furthermore, a satellite broadcast video signal (modulated signal) in the frequency-multiplexed signal is input to the phase modulator 103 from the head-end device (not shown).

The phase modulator 103 modulates the phase of the optical signal directly modulated in accordance with the video signal of the cable television broadcast in accordance with the video signal of the satellite broadcast. The phase modulator 103 outputs the phase-modulated optical signal to the multiplexing unit 104.

The phase-modulated optical signal is input to the multiplexing unit 104 from the phase modulator 103. Furthermore, an optical signal directly modulated in accordance with a video signal of an opposite phase is input to the multiplexing unit 104 from the second laser oscillator 102. The multiplexing unit 104 multiplexes the phase-modulated optical signal and the optical signal directly modulated in accordance with the video signal of an opposite phase.

A detection unit 105 uses a photodiode to perform batch reception processing (optical heterodyne detection) on the multiplexed optical signal. Thus, the detection unit 105 generates a frequency-modulated signal having high linearity. A center frequency of the frequency-modulated signal is “|f1-f2|”.

### CITATION LIST

### Non Patent Documents

[NPD 1] “ITU-T J.185: Transmission equipment for transferring multi-channel television signals over optical access networks by frequency modulation conversion, [Online], [retrieved on Aug. 24, 2020], the Internet <URL: https://www.itu.int/rec/T-REC-J.185-201206-I/en>
[NPD 2] Toshiaki SHIMOHA and 2 others, “Optical Video Distribution Technology using FM Conversion Method,” Academic Technical Report IEICE Technical Report CS2019-84, IE2019-64 (2019-12).

### SUMMARY OF INVENTION

### Technical Problem

In the FM conversion system, a frequency modulation unit generates an optical signal directly modulated in accordance with an input video signal (modulation signal) by using two laser beams. Very high linearity is required for the characteristics between a bias current and an oscillation frequency in these two laser beams. Therefore, there is a problem that the selection cost of each laser oscillator is very high. In order to solve this problem, it is conceivable that a phase modulator be connected to a subsequent stage of one of the two laser oscillators, and then all of the transmitted video signals be input to the phase modulator.

FIG. 5 is a diagram showing a second example of a configuration of a frequency modulation unit provided in an optical transmission device of an optical transmission system. The frequency modulation unit 110 includes a first laser oscillator 111, a second laser oscillator 112, a phase modulator 113, a multiplexing unit 114, a detection unit 115, and an amplification unit 116.

The first laser oscillator 111 generates laser light on the basis of the first oscillation frequency “f1”. The first laser oscillator 111 outputs a laser beam based on the first oscillation frequency “f1” to the phase modulator 113. The second laser oscillator 112 generates a laser beam on the basis of the second oscillation frequency “f2”. The second laser oscillator 112 outputs a laser beam based on the second oscillation frequency “f2” to the multiplexing unit 114.

A video signal of cable television broadcasting and a video signal of satellite broadcasting are input to the amplification unit 116 as a frequency-multiplexed signal from the head-end device (not shown). The amplification unit 116 amplifies the amplitudes of these video signals to about several volts to obtain a sufficient frequency deviation amount in the frequency-modulated signal. The amplification unit 116 outputs the video signal whose amplitude is amplified to the phase modulator 113.

The phase modulator 113 generates an optical signal phase-modulated by using the video signal whose amplitude is amplified by using a laser beam based on the first oscillation frequency “f1”. The phase-modulated optical signal is input to the multiplexing unit 114 from the phase modulator 113. A laser beam based on a second oscillation frequency “f2” is input to the multiplexing unit 114 from the second laser oscillator 112.

The multiplexing unit 104 multiplexes the phase-modulated optical signal and the laser beam based on the second oscillation frequency “f2”. The detection unit 115 uses a photodiode to perform batch reception processing (optical heterodyne detection) on the multiplexed optical signal.

However, since the signal quality deteriorates due to the distortion generated in the video signal in the amplification unit 116 in the frequency modulator 110, the noise characteristics and the distortion characteristics cannot be improved in some cases.

In view of the above circumstances, an object of the present invention is to provide an optical transmission device, an optical transmission method, and an optical transmission system capable of improving noise characteristics and distortion characteristics.

### Solution to Problem

An aspect of the present invention is an optical transmission device which includes a distribution unit which generates a first modulated signal and a second modulated signal by distribution processing for an input signal; a first phase modulator which generates a first optical signal phase-modulated in accordance with the first modulated signal by using a laser beam based on a first oscillation frequency; a phase adjustment unit which generates the second modulated signal of a phase opposite to a phase of the first modulated signal; a second phase modulator which generates a second optical signal phase-modulated in accordance with the second modulated signal of the opposite phase by using a laser beam based on a second oscillation frequency; a multiplexing unit which multiplexes the first optical signal and the second optical signal; and a detection unit which generates a frequency-modulated signal by performing square-law detection processing on a result of multiplexing the first optical signal and the second optical signal.

An aspect of the present invention is an optical transmission method performed by an optical transmission device, the optical transmission method including: a distribution step of generating a first modulated signal and a second modulated signal by distribution processing for an input signal; a first phase modulation step of generating a first optical signal phase-modulated in accordance with the first modulated signal by using a laser beam based on a first oscillation frequency; a phase adjustment step of generating the second modulated signal having a phase opposite to a phase of the first modulated signal; a second phase modulation step of generating a second optical signal which is phase-modulated in accordance with the second modulated signal of the opposite phase by using a laser beam based on the second oscillation frequency; a multiplexing step of multiplexing the first optical signal and the second optical signal; and a detection step of generating a frequency-modulated signal by performing square-law detection processing on a result of multiplexing the first optical signal and the second optical signal.

An aspect of the present invention is an optical transmission system including an optical transmission device, an optical subscriber line terminal station device, and an optical line terminal device in which the optical transmission device includes: a distribution unit which generates a first modulated signal and a second modulated signal by distribution processing for an input signal; a first phase modulator which generates a first optical signal phase-modulated in accordance with the first modulated signal using a laser beam based on the first oscillation frequency; a phase adjustment unit which generates the second modulated signal having a phase opposite to a phase of the first modulated signal; a second phase modulator which generates a second optical signal which is phase-modulated in accordance with the second modulated signal of the opposite phase by using a laser beam based on the second oscillation frequency; a multiplexing unit which multiplexes the first optical signal and the second optical signal; a detection unit which generates a frequency-modulated signal by performing square-law detection processing on a result of multiplexing the first optical signal and the second optical signal; and an intensity modulator which generates a third optical signal which is intensity-modulated in accordance with the frequency-modulated signal, the optical subscriber line terminal station device transmits the third optical signal, and the optical line terminal device acquires the third optical signal.

### Advantageous Effects of Invention

According to the present invention, it is possible to improve noise characteristics and distortion characteristics.

### BRIEF DESCRIPTION OF DRAWINGS

FIG. 1 is a diagram showing a configuration example of an optical transmission system according to an embodiment.

FIG. 2 is a diagram showing a configuration example of a frequency modulation unit in the embodiment.

FIG. 3 is a flowchart for describing an operation example of the frequency modulation unit in the embodiment.

FIG. 4 is a diagram showing a first example of a configuration of a frequency modulation unit provided in an optical transmission device of an optical transmission system.

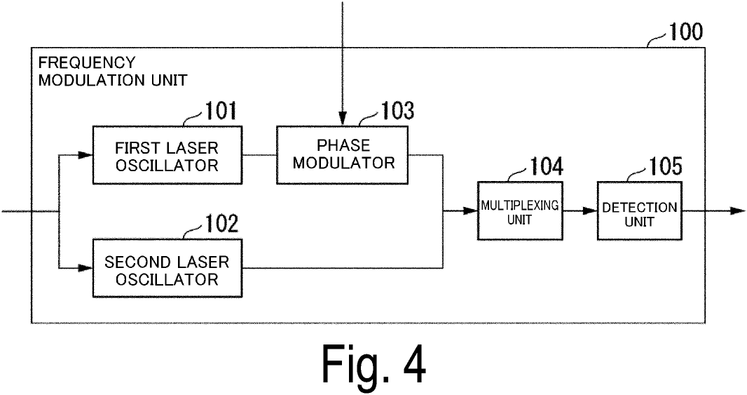

FIG. 5 is a diagram showing a second example of the configuration of a frequency modulation unit provided in an optical transmission device of an optical transmission system.

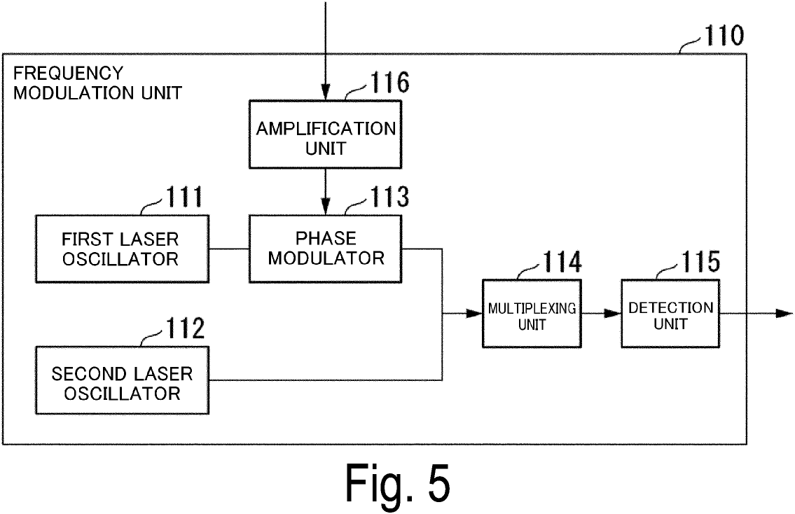

### DESCRIPTION OF EMBODIMENTS

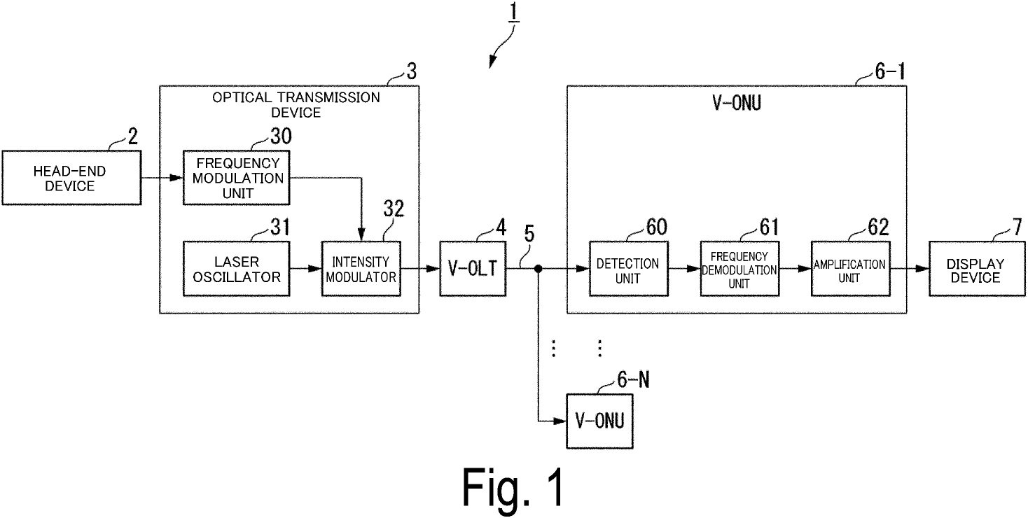

Embodiments of the present invention will be described in detail with reference to the drawings. FIG. 1 is a diagram showing a configuration example of an optical transmission system 1. The optical transmission system 1 is a system configured to transmit an optical signal. In the following description, the optical transmission system 1 distributes a video signal by using an optical signal, as an example. A video may be a moving image or a still image.

The optical transmission system 1 includes a head-end device 2, an optical transmission device 3 (optical transmitting apparatus), a V-OLT 4, a transmission path 5, N (N is an integer of 1 or more) V-ONUs 6, and a display device 7. The optical transmission device 3 includes a frequency modulation unit 30, a laser oscillator 31, and an intensity modulator 32. The V-ONU 6 includes a detection unit 60, a frequency demodulation unit 61, and an amplification unit 62.

The head-end device 2 outputs a frequency-multiplexed signal including a video signal (modulation signal) to the optical transmission device 3. Note that the modulation signal may be, for example, an audio signal or a data signal.

The optical transmission device 3 is a device which transmits an optical signal. The frequency modulation unit 30 performs square-law detection processing on an optical beat between the first optical signal which is phase-modulated in accordance with the video signal and the second optical signal which is phase-modulated in accordance with the video signal of the opposite phase. Thus, the frequency modulation unit 30 generates a frequency-modulated signal (FM signal).

The laser oscillator 31 generates a laser beam for transmission. The intensity modulator 32 is a device which performs intensity modulation on the laser beam for transmission in accordance with the frequency-modulated signal. The intensity modulator 32 generates an intensity-modulated optical signal (third optical signal) by using a laser beam for transmission. The intensity modulator 32 transmits the intensity-modulated optical signal to the V-OLT 4.

The V-OLT 4 (video-optical line terminal) is an optical subscriber line terminal station device. The V-OLT 4 transmits the optical signal intensity-modulated by the intensity modulator 32 to each V-ONU 6 via the transmission path 5. The transmission path 5 transmits an optical signal using an optical fiber. The transmission path 5 distributes the optical signal from V-ONU 6-1 to V-ONU 6-N by using an optical splitter.

The V-ONU 6 (video-optical line terminal device) is an optical line terminal device. The detection unit 60 has a photodiode. The detection unit 60 converts an optical signal (third optical signal) acquired via the transmission path 5 into a frequency-modulated signal (electrical signal). The frequency demodulation unit 61 generates a frequency-multiplexed signal including a video signal by performing demodulation processing on the frequency-modulated signal. The demodulation process includes a process of detecting rising of the frequency-modulated signal and a process of detecting falling of the frequency-modulated signal. The amplification unit 62 amplifies the amplitude of the video signal in the frequency-multiplexed signal to a predetermined level.

The display device 7 is a device which displays a video on a screen. The display device 7 acquires a frequency-multiplexed signal including a video signal whose amplitude is amplified to a predetermined level from the amplification unit 62. The display device 7 displays a video on a screen in accordance with the video signal in the frequency-multiplexed signal.

A configuration example of the frequency modulation unit 30 will be described below.

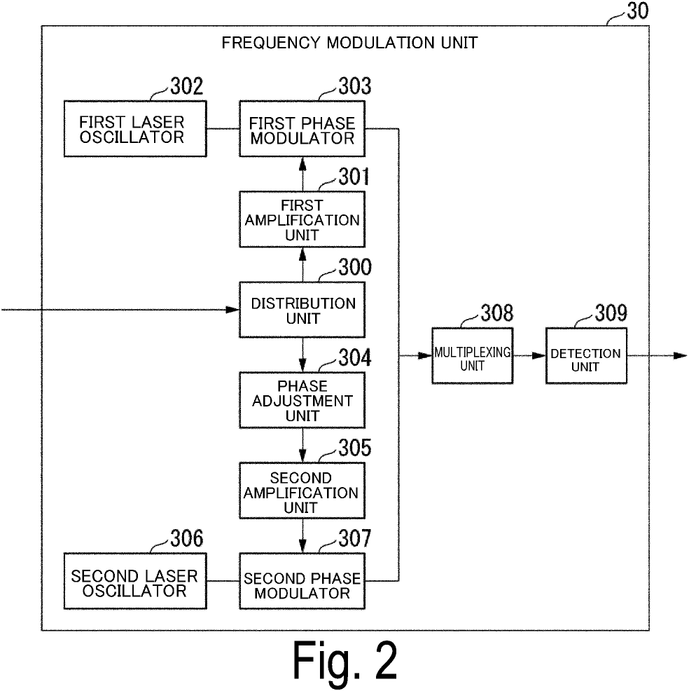

FIG. 2 is a diagram showing a configuration example of the frequency modulation unit 30. The frequency modulation unit 30 includes a distribution unit 300, a first amplification unit 301, a first laser oscillator 302, a first phase modulator 303, a phase adjustment unit 304, a second amplification unit 305, a second laser oscillator 306, a second phase modulator 307, a multiplexing unit 308, and a detection unit 309.

A frequency-multiplexed signal including a video signal (modulated signal) is input to the distribution unit 300 from the head-end device 2 as an input signal. In the following description, the video signals are, for example, a video signal of cable television broadcasting and a video signal of satellite broadcasting (intermediate frequency (IF) signal).

The video signal of cable television broadcasting is, for example, amplitude modulation (AM) for analog broadcasting and a quadrature amplitude modulation (QAM) signal for digital broadcasting which are included in a band from 70 MHz to 770 MHz. The video signal of satellite broadcasting is, for example, a broadcast satellite (BS) signal and a communication satellite (CS) 110 degree signal which are included in a band from 1.0 GHz to 2.1 GHz.

The distribution unit 300 distributes a frequency-multiplexed signal including a video signal (modulated signal) to the first amplification unit 301 and the phase adjustment unit 304. A video signal is input to the first amplification unit 301 from the distribution unit 300. The first amplification unit 301 amplifies the amplitude of the video signal to a predetermined level. The first amplification unit 301 outputs the video signal whose amplitude is amplified to the first phase modulator 303.

The first laser oscillator 302 is a laser diode. The first laser oscillator 302 generates a laser beam on the basis of the first oscillation frequency “f1”. The first laser oscillator 302 outputs a laser beam based on the first oscillation frequency “f1” to the first phase modulator 303.

A laser beam based on the first oscillation frequency “f1” is input to the first phase modulator 303 from the first laser oscillator 302. A video signal (modulated signal) whose amplitude is amplified is input to the first phase modulator 303 from the first amplification unit 301. The first phase modulator 303 generates an optical signal phase-modulated in accordance with the video signal whose amplitude is amplified by using a laser beam based on the first oscillation frequency “f1”. The first phase modulator 303 outputs an optical signal phase-modulated in accordance with the video signal whose amplitude is amplified to the multiplexing unit 308. Hereinafter, a frequency deviation amount of the optical signal phase-modulated by the first phase modulator 303 is referred to as “ΔFₘ₁”.

A video signal is input to the phase adjustment unit 304 from the distribution unit 300. The phase adjustment unit 304 inverts a phase of the video signal. That is to say, the phase adjustment unit 304 generates a video signal (modulated signal) of an opposite phase. The phase adjustment unit 304 outputs a video signal of the opposite phase to the second amplification unit 305.

The second amplification unit 305 amplifies the amplitude of the video signal of the opposite phase to a predetermined level. The second amplification unit 305 outputs the video signal of an opposite phase whose amplitude is amplified to the second phase modulator 307.

The second laser oscillator 306 is a laser diode. The second laser oscillator 306 generates a laser beam on the basis of the second oscillation frequency “f2”. The second laser oscillator 306 outputs a laser beam based on the second oscillation frequency “f2” to the second phase modulator 307.

A laser beam based on the second oscillation frequency “f2” is input to the second phase modulator 307 from the second laser oscillator 306. A video signal (modulated signal) of an opposite phase is input to the second phase modulator 307 from the second amplification unit 305. The second phase modulator 307 generates an optical signal phase-modulated in accordance with the video signal whose amplitude is amplified by using a laser beam based on the second oscillation frequency “f2”. The second phase modulator 307 outputs an optical signal phase-modulated in accordance with the video signal of an opposite phase whose amplitude is amplified to the multiplexing unit 308. Hereinafter, the frequency deviation amount of the optical signal phase-modulated by the second phase modulator 307 is referred to as “ΔFₘ₂”.

In the multiplexing unit 308, an optical signal phase-modulated in accordance with the video signal is input from the first phase modulator 303. Furthermore, an optical signal phase-modulated in accordance with a video signal of an opposite phase is input to the multiplexing unit 308 from the second phase modulator 307. The multiplexing unit 308 multiplexes the optical signal phase-modulated in accordance with the video signal and the optical signal phase-modulated in accordance with the video signal of an opposite phase. The multiplexing unit 308 outputs the multiplexed optical signal to the detection unit 309.

The detection unit 309 has a photodiode. The detection unit 309 uses the photodiode to perform square-law detection processing on the multiplexed optical signal. As a result, the detection unit 309 generates a frequency modulation signal (FM signal). A modulation index of the video signal (input signal) in the frequency modulation signal received by the photodiode of the detection unit 309 is “ΔFₘ₁+ΔFₘ₂”. The detection unit 309 outputs a wide band (for example, from 500 MHz to 6 GHz) frequency modulation signal to the intensity modulator 32.

An operation example of the frequency modulation unit 30 will be described below.

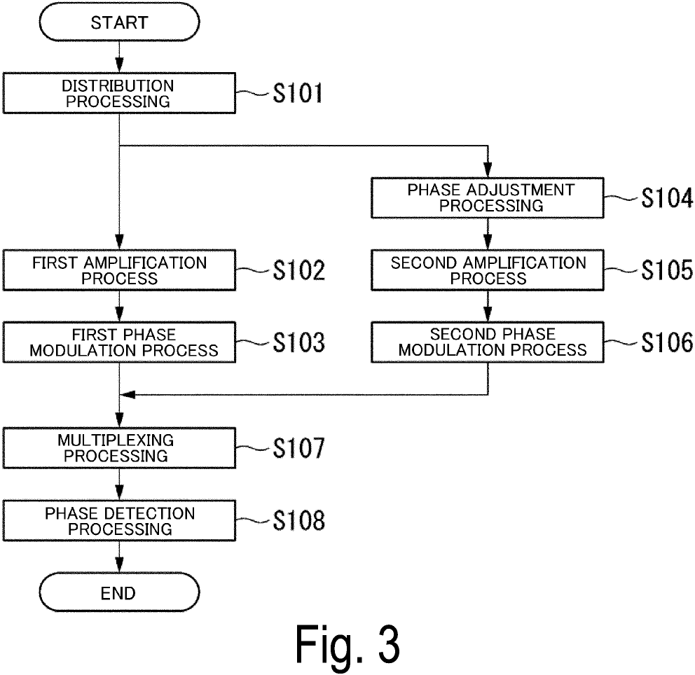

FIG. 3 is a flowchart for describing an operation example of the frequency modulation unit 30. The distribution unit 300 outputs the first video signal (first modulated signal) to the first amplification unit 301 and outputs the second video signal (second modulated signal) to the phase adjustment unit 304 by the distribution processing for the input signal (Step S101).

The first amplification unit 301 amplifies the amplitude of the first video signal to a predetermined level (Step S102). The first phase modulator 303 generates an optical signal phase-modulated in accordance with the first video signal whose amplitude is amplified by using a laser beam based on the first oscillation frequency “f1” (Step S103).

The phase adjustment unit 304 inverts a phase of the second video signal. That is to say, the phase adjustment unit 304 generates a video signal (modulated signal) of an opposite phase (Step S104). The second amplification unit 305 amplifies the amplitude of the video signal of an opposite phase to a predetermined level (Step S105). The second phase modulator 307 generates an optical signal phase-modulated in accordance with the video signal whose amplitude is amplified by using a laser beam based on the second oscillation frequency “f2” (Step S106).

The multiplexing unit 308 multiplexes a phase-modulated optical signal (first optical signal) in accordance with the video signal and a phase-modulated optical signal (second optical signal) in accordance with the video signal of an opposite phase (Step S107). The detection unit 309 generates a frequency modulation signal (FM signal) by performing a square-law detection process on the result of multiplexing the first optical signal and the second optical signal (Step S108).

As described above, the distribution unit 300 generates the first modulated signal and the second modulated signal by the distribution processing for the input signal. The first phase modulator 303 generates a first optical signal phase-modulated in accordance with the first modulated signal by using a laser beam based on the first oscillation frequency “f1”. The phase adjustment unit 304 generates a second modulated signal of a phase opposite to the phase of the first modulated signal. The second phase modulator 307 generates a second optical signal phase-modulated in accordance with the second modulated signal of an opposite phase by using a laser beam based on the second oscillation frequency “f2”. The multiplexing unit 308 multiplexes the first optical signal and the second optical signal. The detection unit 309 generates a frequency modulation signal (FM signal) by performing a detection process (for example, a square-law detection process) on the result of multiplexing the first optical signal and the second optical signal. The intensity modulator 32 generates a third optical signal intensity-modulated in accordance with the frequency modulation signal by using a laser beam for transmission. The V-OLT 4 (optical subscriber line terminal station device) transmits a third optical signal. The V-ONU 6 (optical line terminal device) acquires a third optical signal.

Here, since the amplitude of the video signal (modulated signal) input to the first phase modulator 303 can be reduced, an amplification factor of the amplitude of the video signal in the first amplification unit 301 can be lowered and a small distortion of the video signal input to the first phase modulator 303 is provided. Similarly, since the amplitude of the video signal (modulated signal) input to the second phase modulator 307 can be reduced, the amplification factor of the amplitude of the video signal in the second amplification unit 305 can be lowered and the small distortion of the video signal input to the second phase modulator 307 is provided. Furthermore, a line width of a laser beam of the first laser oscillator 302 may be reduced. Similarly, a line width of a laser beam of the second laser oscillator 306 may be reduced. Therefore, it is possible to improve noise characteristics.

This makes it possible to improve noise characteristics and distortion characteristics in the optical transmission system which generates a frequency-modulated signal by using optical beats.

As described above, in the FM conversion method having excellent noise characteristics and distortion characteristics, the voltage of the video signal input to the first phase modulator 303 and the second phase modulator 307 can be lowered. Therefore, the quality of the video signal is unlikely to deteriorate even if the amplitude of the video signal input to the first phase modulator 303 and the second phase modulator 307 increases due to channel addition, band increase, or the like.

A part or all of each functional part of the optical transmission system 1 is realized as software when a processor such as a central processing unit (CPU) executes a program stored in a storage device having a non-volatile recording medium (non-transitory recording medium) and a memory. The program may be recorded on a computer-readable recording medium. Examples of the computer-readable recording medium include portable media such as flexible disks, magneto-optical disks, read only memories (ROMs), and compact disc read only memories (CD-ROMs) and non-transitory recording media such as storage devices such as hard disks built into computer systems.

A part or all of each functional part of the optical transmission system 1 may be realized by using, for example, hardware including electronic circuits (electronic circuits or circuits) using large scale integrated (LSI) circuits, application specific integrated circuits (ASICs), programmable logic devices (PLDs), field programmable gate arrays (FPGAs), or the like.

Although the embodiments of the present invention have been described in detail with reference to the drawings, specific configurations are not limited to these embodiments, and designs and the like within a range that does not deviating from the gist of the present invention are also included.

### INDUSTRIAL APPLICABILITY

The present invention is applicable to a video distribution system.

### REFERENCE SIGNS LIST

1 Optical transmission system
2 Head-end device
3 Optical transmission device
4 V-OLT
5 Transmission path
6 V-ONU
7 Display device
30 Frequency modulation unit
31 Laser oscillator
32 Intensity modulator
60 Detection unit
61 Frequency demodulation unit
62 Amplification unit
100 Frequency modulation unit
101 First laser oscillator
102 Second laser oscillator
103 Phase modulator
104 Multiplexer
105 Detection unit
110 Frequency modulation unit
111 First laser oscillator
112 Second laser oscillator
113 Phase modulator
114 Multiplexing unit
115 Detection unit
116 Amplification unit
300 Distribution unit
301 First amplification unit
302 First laser oscillator
303 First phase modulator
304 Phase adjustment unit
305 Second amplification unit
306 Second laser oscillator
307 Second phase modulator
308 Multiplexing unit
309 Detection unit

1. An optical transmission device comprising:
a distributor which generates a first modulated signal and a second modulated signal by distribution processing for an input signal;
a first phase modulator which generates a first optical signal phase-modulated in accordance with the first modulated signal by using a laser beam based on a first oscillation frequency;
a phase adjuster which generates the second modulated signal of a phase opposite to a phase of the first modulated signal;
a second phase modulator which generates a second optical signal phase-modulated in accordance with the second modulated signal of the opposite phase by using a laser beam based on a second oscillation frequency;
a multiplexer which multiplexes the first optical signal and the second optical signal; and
a detector which generates a frequency-modulated signal by performing square-law detection processing on a result of multiplexing the first optical signal and the second optical signal.

2. An optical transmission method performed by an optical transmission device, the optical transmission method comprising:
generating a first modulated signal and a second modulated signal by distribution processing for an input signal;
generating a first optical signal phase-modulated in accordance with the first modulated signal by using a laser beam based on a first oscillation frequency;
generating the second modulated signal having a phase opposite to a phase of the first modulated signal;
generating a second optical signal which is phase-modulated in accordance with the second modulated signal of the opposite phase by using a laser beam based on the second oscillation frequency;
multiplexing the first optical signal and the second optical signal; and
generating a frequency-modulated signal by performing square-law detection processing on a result of multiplexing the first optical signal and the second optical signal.

3. An optical transmission system including an optical transmission device, an optical subscriber line terminal station device, and an optical line terminal device, wherein
the optical transmission device includes:
a distributor which generates a first modulated signal and a second modulated signal by distribution processing for an input signal;
a first phase modulator which generates a first optical signal phase-modulated in accordance with the first modulated signal using a laser beam based on the first oscillation frequency;
a phase adjuster which generates the second modulated signal having a phase opposite to a phase of the first modulated signal;
a second phase modulator which generates a second optical signal which is phase-modulated in accordance with the second modulated signal of the opposite phase by using a laser beam based on the second oscillation frequency;
a multiplexer which multiplexes the first optical signal and the second optical signal;
a detector which generates a frequency-modulated signal by performing square-law detection processing on a result of multiplexing the first optical signal and the second optical signal; and
an intensity modulator which generates a third optical signal which is intensity-modulated in accordance with the frequency-modulated signal, and
the optical subscriber line terminal station device transmits the third optical signal, and
the optical line terminal device acquires the third optical signal.
